(19) United States
(12) Patent Application Publication
(10) Pub. No.: US 2004/0181447 A1
(43) Pub. Date: Sep. 16, 2004

(54) Method of inducing customers to increase their patronage of a business establishment

(76) Inventor: Peter Brandon, Valatie, NY (US)

Correspondence Address: Todd S. Parkhurst, Holland & Knight LLC, 30th Floor, 131 S. Dearborn, Chicago, IL, 60603-5144, US

(21) Appl. No.: 10/384,982

(22) Filed: Mar. 12, 2003

(51) Int. Cl. G06F 17/60

(52) U.S. Cl. 705/14

(57) ABSTRACT

A method of inducing customers to increase the business they transact with a business establishment is disclosed and claimed. The method comprises the step of offering a reward to customers of the business establishment for making at least a predefined plurality of purchases from the business establishment within a predetermined time period. An Internet web site can be created for the business establishment, and customers can be induced to make purchases through the web site. A web site computer can record the identity of the customers who make purchases through the web site, and can record the date and time each purchase is made, and the value of each such purchase. A reward can be offered to identified customers for making at least a predefined plurality of purchases from the business establishment within a predetermined time period. If desired, the reward can be related to the value of those purchases.

This invention relates generally to business methods, and more particularly concerns methods of inducing customers to increase the number of and value transactions they transact with a business establishment.

In today's highly competitive business environment, business establishments constantly search for methods of inducing existing and potential customers to increase the business they transact with that business establishment. Some business operators have offered to provide customers with discounts or rebates on future purchases if those customers will purchase more than a predetermined monetary value of goods or services from the business establishment.

The advent of computerized accounting systems for tracking sales and customer preferences enables even small business operators to provide more sophisticated and more effective discount and inducement plans for the customers of those business operators.

It is an object of this invention to provide a highly effective sales inducement plan which can be operated at little or no additional overhead cost.

It is a related object to provide such a sales inducement plan which can be easily understood and easily used by the customers of the business establishment.

Other objects and advantages of the invention will become apparent upon reading the following detailed description. While the invention will be described in connection with a preferred embodiment and procedure, it will be understood that it is not intended to limit the invention to this embodiment or procedure. On the contrary, it is intended to cover all alternatives, modifications and equivalents as may be included within the spirit and scope of the invention as defined by the appended claims.

The above objects can be carried out by a novel method of inducing customers to increase the business they transact with a business establishment. In accordance with the invention, this novel method comprises the following:

1. Discount or Free Merchandise For Frequency of Purchases. This business method is a reward of free merchandise or a discount on a purchase, when a customer makes a certain number of purchases within a certain period of time. For example, a pizza restaurant may offer a series of discounts to customers who make frequent purchases within a given week, such as 10% off any second meal purchased within a calendar week, 15% off any third meal purchased within that calendar week, and 20% off any forth meal purchased within that calendar week. The reward can be expressed either as a percentage discount or as an award of free merchandise: For example, a free soda can be offered with the second meal purchased within a calendar week, free soda and a free desert can be awarded for the third meal purchased within a given calendar week, a free soda, free desert, and free side dish can be awarded for the forth meal purchased with a given calendar week.

2. Credit: Value Related To Purchases. A reward of a credit on the next purchase, or some future purchase or purchases, after a customer has made a certain number of purchases within a given period of time can be provided. The credit can be made to equal the highest price, or the lowest price of any of the previous purchases, or the average price of all of the previous purchases. For example, a pizza restaurant may offer a reward to customers who purchase ten meals in forty days. The credit could be equal to the lowest price, or the highest price paid for any of the previous ten meals purchased, or the average price of all ten meals purchased in accordance with this offer.

Merchants sometimes offer rewards for more purchases within a given transaction (two for the price of one). Also, merchants sometimes offer rewards for greater dollar volume of purchases (point or mileage rewards.) What distinguishes this business method is that it is a reward to a customer for making more individual purchases of any value with a certain period of time.

Tracking number of purchases, and the monetary value of those purchases, can be accomplished with accuracy and minimal expense by a suitably programmed computer. If desired, the purchases can be conducted, and transparently tracked, through an Internet web site.

A standard electronic commerce software program can be used, and can be modified by the addition of the code set forth in Appendix A, to provide the functions and operations suggested here.

The nature or sort of purchases can be varied to- suit the individual needs of the restaurant or business establishment. For example, the purchases from a restaurant can include pickup (takeout) purchases and delivery purchases of food from that restaurant.

The administration of such an inducement plan can be minimized, and the effectiveness of the plan can be maximized, by utilizing suitably programmed computers and, if desired, Internet websites. For example, the business operator can create (or have created) an Internet website designed to implement the aforementioned business methods.

Each customer making a purchase through the Internet website can be provided with a unique password or identification code. When the customer makes a purchase through the Internet website utilizing that password or identification code, the computer records the identity of the customer, the date and time when the purchase was made. Rewards can be offered to customers of the business establishment for making at least a predetermined plurality of purchases from the business establishment within a predetermined time period. In addition, if desired, the rewards can be restricted to those customers whose total purchases meet or exceed a predetermined minimum monetary value, or the magnitude of the reward can be related to the monetary value of the customer's previous purchases.

It will be apparent that this reward system can be employed by businesses utilizing Internet sales web sites. If the business operator desires to encourage customers to personally frequent his or her business establishment, the operator might provide each customer with a plastic account card, for example. The customer can present the card when personally placing orders in the store, or a customer can use the card identifying indicia when placing orders over the Internet. Moreover, the employment of such cards would allow a multi-store business to offer this reward system to customers who make purchases at a number of stores owned or franchised by the business operation. Cash registers or supplemental equipment such as card readers, computers and screens at each store could be connected to the Internet and website so as to transfer customer information and purchase information to a computer dedicated to tracking an accounting for customer inducement purchases and administer this frequency of purchase reward system. All purchases, rewards and discounts can be tracked and calculated regardless of whether purchases are made online or in person at a store or restaurant.

1. A method of inducing customers to increase the business they transact with a business establishment, comprising the step of offering a reward to customers of the business establishment for making at least a predefined plurality of purchases from the business establishment within a predetermined time period.

2. A method according to claim 1 wherein the step of offering a reward to customers, of the business for making said at least a predetermined plurality of purchases includes the step of restricting said reward to only those customers whose total purchases exceed a predetermined value.

3. A method according to claim 1 wherein said business establishment is a restaurant.

4. A method of according to claim 3 wherein said purchases comprise purchases of food from said restaurant.

5. A method according to claim 4 wherein said purchases comprise pickup and takeout purchases and delivery purchases of food from said restaurant.

6. A method according to claim 1 wherein the step of offering a reward to customers of the business includes the step of offering a discount on a future purchase, said discount being based upon to the average value amount of purchases made during a predetermined time period.

7. A method of inducing customers to increase the business they transact with a business establishment, comprising the steps of
creating an Internet website for the business establishment,
inducing the customers to make purchases through the Internet website,
recording the identity of the customers who make purchases to the website,
recording the date and time when each said purchase is made,
recording the value of each said purchase, and
offering a reward to identified customers of the business establishment for making at least a predefined plurality of purchases from the business establishment within a predetermined time period.

8. A method according to claim 7 wherein said step of offering a reward includes the step of formulating the reward so as to provide a discount to said customer on at least one future purchase, the size of the discount being related to both the total number and total value of the customer's past purchases within a predetermined time period.
